(19) United States
(12) Patent Application Publication
(10) Pub. No.: US 2003/0080996 A1
(43) Pub. Date: May 1, 2003

(54) Software for a navigation control unit for use with a wireless computer resource access device and associated system

(76) Inventors: Daniel Lavin, San Francisco, CA (US); Henriette Wendt, London (GB); Robert Cousins, Crawley (GB); Willliam Rini, Marina del Rey, CA (US)

Correspondence Address: ST. ONGE STEWARD JOHNSTON & REENS, LLC, 986 BEDFORD STREET, STAMFORD, CT, 06905-5619, US

(21) Appl. No.: 10/269,155

(22) Filed: Oct. 11, 2002

Related U.S. Application Data
(63) Continuation of application No. PCT/US01/12166, filed on Apr. 12, 2001.

(30) Foreign Application Priority Data
Apr. 13, 2000 (GB) 0009004.3

(51) Int. Cl. G09G 5/00

(52) U.S. Cl. 345/738; 345/968

(57) ABSTRACT

A method automatically configures a wireless network access device, such as a wireless access protocol (“WAP”) enabled mobile phone. The method, which may be embodied in a separate attachment that may be removably secured to a wireless access device, automatically configures the wireless access device to facilitate the access or retrieval of resources on the computer network. In one embodiment, a WAP enabled cell phone is coupled to a navigation control unit that automatically configures the phone to access a predetermined web page or site on the Internet. User controls, such as buttons, on the navigation control unit allow a user to quickly access predefined resources on the Internet (such as predetermined web pages or web sites), by pushing a single button, rather than requiring the user to enter a complicated series of key presses on the phone. While a cell phone is described, various other embodiments are also described under the invention.

### CROSS-REFERENCE TO RELATED APPLICATION

This application claims the benefit of U.K. Patent Application No. GB 0009004.3, filed Apr. 13, 2000, currently pending.

### TECHNICAL FIELD

The present disclosure relates in general to a navigation control unit for use with a wireless resource access device.

### BACKGROUND

The Internet comprises a vast number of computers and computer networks interconnected through communication channels. The Internet is used for a variety of reasons, including electronic commerce, exchanging information such as electronic mail, retrieving information and doing research, and the like. Many standards have been established for exchanging information over the Internet such as electronic mail, Gopher, and the World Wide Web (“WWW”). The WWW service allows a server computer system (i.e., web server or web site) to send graphical web pages of information to a remote client computer system The remote client computer system can then display the web pages. Each resource (e.g., computer or web page) of the WWW is uniquely identifiable by a Uniform Resource Locator (“URL”). To view a specific web page, a client computer system specifies the URL for that web page in a request (e.g., a HyperText Transfer Protocol (“HTTP”) request). The request is forwarded to the web server that supports that web page. When that web server receives the request, it sends the requested web page to the client computer system. When the client computer system receives that web page, it typically displays the web page using a browser. A browser is typically a special-purpose application program for requesting and displaying web pages.

Currently, web pages are often defined using HyperText Markup Language (“HTML”). HTML provides a standard set of tags that define how a web page is to be displayed When a user makes a request to the browser to display a web page, the browser sends the request to the server computer system to transfer to the client computer system an HTML document that defines the web page. When the requested HTML document is received by the client computer system, the browser displays the web page as defined by the HTML document The HTML document contains various tags that control the display of text, graphics, controls, and other features. The HTML document may contain URLs of other web pages available on that server computer system or on other server computer systems.

New protocols exist, such as Extensible Mark-up Language (“XML”) and Wireless Access Protocol (“WAP”). XML provides greater flexibility over HTML. WAP provides, among other things, the ability to view web pages over hand-held, wireless devices, such as cell phones and portable computers (e.g., PDA's).

Recently, portable communication devices such as mobile telephones have been developed for access to information on a local or global computer network. These devices come in many different forms including, for example, a mobile telephone or a palm top computer, and will be referred to generally as a wireless web access device.

Customers of the wireless web access device desire to have devices that provide a large amount of functionality and yet are small lightweight, and affordable. To accommodate these conflicting desires, manufacturers have made the user controls smaller and have made each user control perform potentially a variety of functions. For example, many wireless web access devices require users to press a small button up to three times in order to input just one character Moreover, users often have to navigate through a large number of web pages or levels of web pages, requiring a large number of often-cumbersome inputs. Accordingly, it is desired to increase both the functionality and ease of use of wireless web access devices.

U.S. Pat. No. 5,854,624 to Grant, issued Dec. 29, 1998 (“Grant”) discloses a pocket-sized user interface for accepting user input for a separate Internet browser terminal designed to, among other things, reduce carpal tunnel syndrome for people using traditional computer keyboards to browse the Internet on their personal computer. The user interface of Grant must be less than 0.45 inches in thickness and roughly the length, width, and shape of a standard credit card. The interface is connected to a browser terminal via a translator, which converts the commands to a form acceptable to the browser terminal, and the translator is preferably connected to both the browser terminal and the user interface with a cord. The buttons on Grant are programmed to provide linking commands to a variety of websites. The user interface of Grant, however, is plagued with is problems. For example, the user interface Grant is severely limited in size, shape and functionality and requires the use of a translator. In addition, Grant only discloses buttons programmed on the user interface itself, limiting its usefulness relative to the present invention. These are only some of the problems associated with Grant.

Most wireless web access device users are unsophisticated in the operation of such devices, and thus have difficulty reconfiguring them to select a new home page (if this is possible), or even access other web pages. Even if users are capable of operating the device, navigating to desired web pages can be difficult, often involving a complex string of key presses. Thus, users find it difficult to customize their wireless web access devices, and find it difficult to navigate to desired web pages. Furthermore, many of the wireless web access devices are not general purpose computing devices, but instead are task driven for a small set of preferred tasks for the user, not for general browsing or web surfing. These tasks are horizontal across groups of people, such as electronic mail, calendar, address book, and the like. Content on the worldwide web, however, is much more segmented to specific user groups interested in the particular content provided by a particular site. Thus, there is a discontinuity between wireless web access devices, and the content to which they allow users access.

### BRIEF DESCRIPTION OF THE DRAWINGS

FIG. 1 is schematic view of a wireless web access device with a first preferred embodiment of a navigation control unit.

FIG. 2 is a schematic view of a second preferred embodiment of the navigation control unit.

FIG. 3 is a schematic view of a third preferred embodiment of the navigation control unit.

FIG. 4 is a schematic view of a preferred control circuit of the navigation control unit.

FIG. 5 is a flowchart showing a preferred method of operation of the navigation control unit.

FIG. 6 is a flowchart showing a preferred method for providing higher level functionality in the navigation control unit.

FIG. 7 is a block diagram of a suitable computer for employing aspects of the invention.

FIG. 8 is a block diagram illustrating a suitable system in which aspects of the invention may operate in a networked computer environment.

FIG. 9 is a block diagram illustrating an alternative system to that of FIG. 8.

FIG. 10 is a block diagram illustrating a suitable system in which aspects of the invention may operate in a networked computer environment.

FIG. 11 is a flowchart showing a suitable method for providing higher level functionality in the navigation control unit.

FIG. 12 is a block diagram illustrating a suitable user properties lookup table.

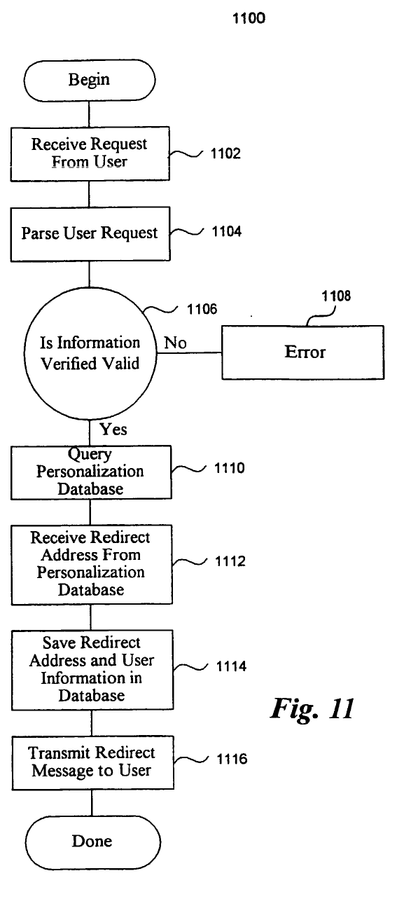

In the drawings, identical reference numbers identify identical or substantially similar elements or acts. To easily identify the discussion of any particular element or act, the most significant digit or digits in a reference number refer to the Figure number in which that element is first introduced (e.g., element 1104 is first introduced and discussed with respect to FIG. 11).

The headings provided herein are for convenience only and do not necessarily affect the scope or meaning of the claimed invention.

### DETAILED DESCRIPTION

The following description provides specific details for a thorough understanding of, and enabling description for, embodiments of the invention. However, one skilled in the art will understand that the invention may be practiced without these details. In other instances, well known structures and functions have not been shown or described in detail to avoid unnecessarily obscuring the description of the embodiments of the invention.

Depicted embodiments of the present invention are intended for use with any suitable portable wireless web access device. By way of example, the preferred embodiments will be described with reference to a wireless web access device 110, such as a mobile telephone, Internet-enabled PDA, automobile-based web access device, or other portable or mobile communication devices. In a preferred embodiment, the wireless web access device 110 is a cellular telephone such as a GSM device, preferably operating under the wireless application protocol (WAP), GPRS, 3G, I-Mode, or other similar communications protocol. The wireless web access device 110 typically has a display screen 111 and integral user controls 112 which are suitably buttons such as membrane switches. In addition, the wireless web access device 110 can be used to access any sort of computer resources, not only web pages, and could also be called a wireless computer resource access device 110.

Under a communications protocol such as WAP, the wireless web access device 110 is used to access a wide range of information on databases linked by a global computer network such as the Internet. The wireless web access device 110 uses a browser function to access the Internet 115 through a gateway portal 114. Navigation between sites and between pages of a site is performed using the integral user controls 112 to control a browser function of the wireless web access device 110. Often it is desired to make the wireless web access device 110 as small as possible and a problem arises in that the integral user controls 112 become smaller and more difficult to operate. Further, it is desired to keep the number of user controls to a minimum for space and cost, but by contrast it is also desired to increase the number of functions available on the device. As a result each integral user control 112 typically performs a number of different functions often operated by pressing the same button several times or by pressing control buttons in various different combinations. Often a user must navigate a menu structure in order for the web access device to perform a desired function. It has been found that a menu structure having more than one or two levels is particularly difficult for users to navigate.

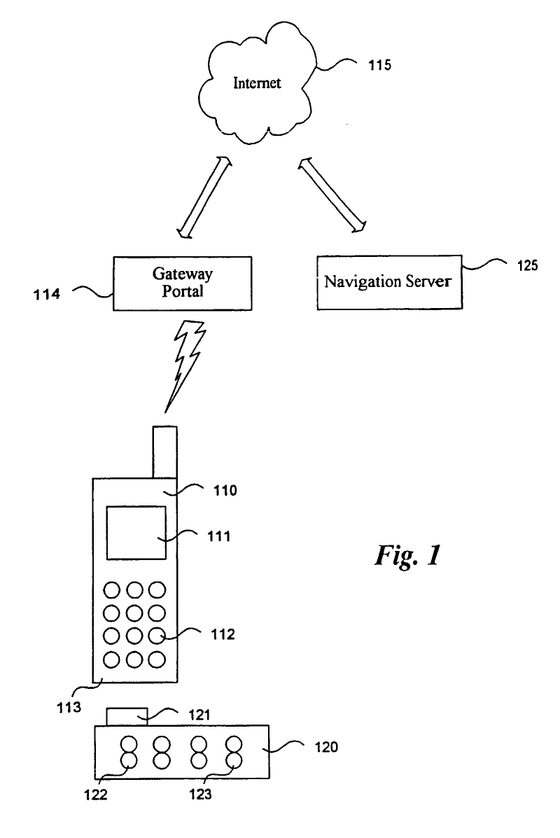

Referring to FIG. 1, in a first preferred embodiment the present invention provides a navigation control unit 120 that is coupleable to the wireless web access device 110. In this embodiment, the navigation control unit 120 is coupleable directly to the wireless web access device 110 such as by a connector 121 entering a corresponding port 113 on the wireless web access device 110. The connector 121 provides both electrical and mechanical coupling between the navigation control unit 120 and the wireless web access device 110. The navigation control unit 120 is supported closely adjacent to the wireless web access device 110. The port 113 in this example is shown at the bottom of the wireless web access device 110, but can be provided elsewhere on the device or remote therefrom such as on an adapter lead.

Unless described otherwise below, the construction and operation of the various blocks shown in FIG. 1 and the other Figures are of conventional design. As a result, such blocks need not be described in further detail beyond that provided herein, because they will be understood by those skilled in the relevant art. Such further detail is omitted for brevity and so as not to obscure the detailed description of the invention. Any modifications necessary to the blocks in FIG. 1 (or other Figures and embodiments) can be readily made by one skilled in the relevant art based on the detailed description provided herein

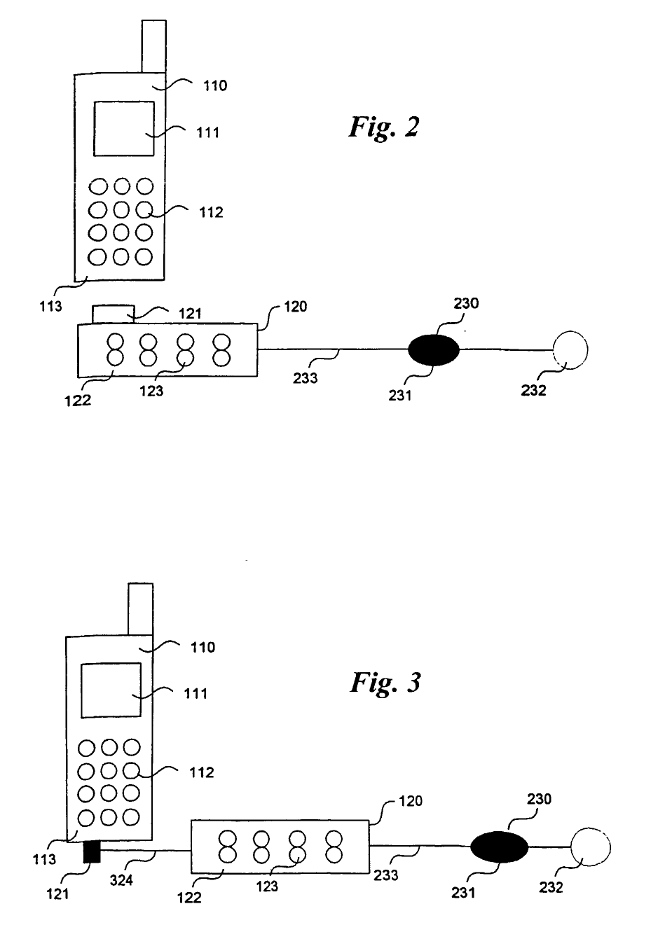

FIG. 2 shows a second preferred embodiment wherein the navigation control unit 120 comprises a handsfree unit 230 including a microphone 231 and an earpiece 232. Suitably, the handsfree unit 230 is coupled to the navigation control unit 120 by a communication link 233, such as a cord. Alternatively, a local wireless link is provided for communication between the navigation control unit 120 and the handsfree unit 230, such as by using optical, infrared or radio frequency signals.

FIG. 3 shows a third preferred embodiment where the navigation control unit 120 is provided remote from the wireless web access device 110 linked by a communication link 324, such as a cord or a local wireless link Conveniently, in this embodiment the wireless web access device 110 may be carried about a user's person such as in a pocket the navigation control unit 120 may be carried separately such as in the hand, on a belt or on a jacket lapel and the handsfree unit 230 may be provided about the user's head.

In an alternative embodiment, the navigation control unit 120 may be attached to a replaceable part of wireless web access device 110, such as a battery pack. In this example, the battery pack and navigation control unit 120 could be packaged and sold together to create a potentially more desirable product. Similarly, any replaceable part related to the wireless web access device 110, such as antennas or removable attachments, could be packaged with a navigation control unit 120.

The navigation control unit 120 may take any suitable form factor. A generally rectangular box is shown in FIGS. 1, 2 and 3 merely for illustration. The navigation control unit 120 may take any suitable size. In the first and second embodiments, at least the part of the navigation control unit 120 in the region of the connector 121 is sized and shaped to correspond with external contours of the wireless web access device 110 in the region of the port 113, giving a neat visual appearance and assisting mechanical stability.

The navigation control unit 120 provides at least one user control 122, and preferably a plurality of user controls as illustrated. These user controls 122 on tie navigation control unit 120 are remote from the integral control buttons 112 provided on the web access device 110. The user controls 122 may take any suitable form, and are preferably keys such as membrane switches. As described herein, a user control 122 may provide any kind of user input, including a request to link to a web site, a scrolling or other control command, powering on or off, data entry, etc. The user control 122 can be of any acceptable design, such as a flat plastic button that the user presses down

Unless described otherwise herein, the blocks depicted in FIGS. 1-3 and many of the other Figures, are well known or described in detail in the above-noted and cross-referenced patent application. Indeed, much of the detailed description provided herein is explicitly disclosed in the above patent application; most or all of the additional material of aspects of the invention will be recognized by those skilled in the relevant at as being inherent in the detailed description provided in such patent application, or well known to those skilled in the relevant art. Those skilled in the relevant art can implement aspects of the invention based on FIGS. 1-3 and the detailed description provided in the patent application.

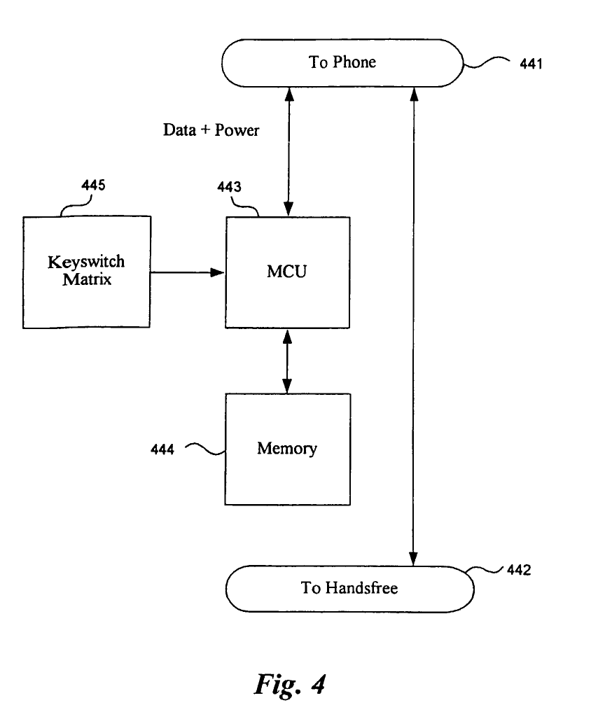

FIG. 4 shows a premed circuit construction for the navigation control unit 120. A first i/o port 441 communicates with the wireless web access device 110. In one example, the i/o port 441 uses an RS232 communications interface. Communications are governed by a protocol such as GSM07.07. Power, for ample at +3.3V or +5V and GND, is drawn through the port 441 from the host wireless web access device 110, or an independent power source is provided. The independent power source could be any suitable power source, including but not limited to batteries, solar-generated power, or power provided by another device, such as an automobile cigarette lighter, a wall outlet, or power source associated with a personal computer. Suitably, audio signals are passed directly from the first i/o port 441 to a second i/o port 442. The second i/o port 442 is coupled to the handsfree unit 230.

The navigation control unit 120 comprises a microprocessor 443 for executing instructions stored on an internal or external memory such as an EPROM, and coupled to internal or external temporary storage 444 such as SDRAM. The microprocessor 443 is coupled to the user controls 122 such as through a keyswitch matrix 445. Further information regarding the external and internal configuration of the navigation control unit and associated elements may be found in U.S. patent application Ser. Nos. ______ and ______, entitled “Hardware Configuraion for a Navigation Control Unit for a Wireless Computer Resource Access Device, such as a Web Access Device,” and “Navigation Control Unit for a Wireless Computer Resource Access Device, such as a Wireless Web Content Access Device,” respectively, both filed concurrently herewith.

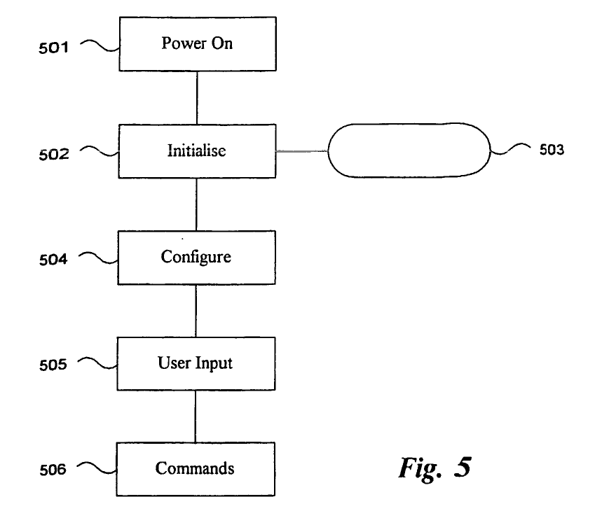

Operation of the navigation control unit 120 will now be described with reference to the flowchart of FIG. 5 as a routine 500. Each of the blocks depicted in FIG. 5 and the other flowcharts is of a sub-operation type that is either well known in the art or may be implemented by those skilled in the relevant art based on the detailed description provided herein. Each block may well include a sequence of operations that need not be described herein. Those skilled in the relevant art can create source code, microcode, or otherwise implement the invention based on the flowchart of FIG. 5 and the detailed description provided herein for operating the navigation control unit The routine 500 is preferably stored in non-volatile memory that forms part of the microprocessor 443 or memory 444, or can be stored in removable media, such as disks, or hardwired or preprogrammed in chips, such as EEPROM semiconductor chips. Those skilled in the relevant art will appreciate that some or all of the routine 500 and other functions and methods described herein can be performed by an application specific integrated circuit (ASIC), by a digital signal processing (DSP) integrated circuit, through conventional programmed logic arrays or other circuit elements.

At step 501 the navigation control unit 120 is powered on, such as by the navigation control unit 120 being connected to the wireless web access device 110 or by the wireless web access device 110 being turned on. At step 502 communications with the web access device 110 are initialized. For example, communication settings such as baud rate are negotiated. Preferably, an identify request is sent to the web access device 110 and a reply received giving identity information of the web access device 110 such as make and model information. In one embodiment if the identity information is not received or is not recognized, operation ends at step 503.

At step 504 the navigation control unit 120 optionally sets configuration parameters of the wireless web access device 110 using configuration commands.

In step 505 the navigation control unit 120 waits for user input such as by polling the keyswitch matrix 445 (as described in relation to FIG. 4). The user controls 122 monitored in step 505 perform any suitable function. In response, at step 506 the navigation control unit 120 sends control commands to the wireless web access device 110.

Operation continues until power to the navigation control unit 120 is removed, such as when the navigation control unit 120 is disconnected from the wireless web access device 110 or when the wireless web access device 110 is turned off.

In one alternative embodiment, the navigation control unit 120 and the wireless web access device 110 are part of the same unit. In other words, the functionality of the navigation control unit 120 can be embodied in a wireless web access device 110. In this embodiment, the steps described below would be performed between different components of the same device.

The configuration commands in step 504 are used to set a wide variety of configuration parameters of the web access device 110. The configuration parameters are determined by the nature and type of the wireless web access device 110. In the example of a GSM cellular device, the wireless web access device 110 dials a predetermined network number when attempting to establish a connection to the Internet through a predetermined gateway portal. The gateway portal is one example configuration parameter that may be set by the navigation control unit 120. Other configuration parameters may set screen displays, including predetermined logos and advertising information. Still other configuration parameters of the wireless web access device 110 include, for example, a home page, bookmarks stored by the wireless web access device 110, and a ringing tone of the wireless web access device 110. The navigation control unit 120 conveniently sets these and other configuration parameters of the wireless web access device 110 for the user automatically and requiring minimal or even no user input. Advantageously, the user avoids navigation of complicated button press arrangements and menu structures in the wireless web access device 110. Also, where configuration parameters are sent over a live network connection, usage of network bandwidth and network time is substantially reduced by the automatic operation of the navigation control unit 120 compared with manual keypresses of the integral user controls 112 by the user. In another alternative embodiment, the connector 121 has memory capability and can store information required to reprogram the wireless web access device 110 or to customize commands for a particular wireless web access device 110.

The commands sent by the navigation control unit 120 in step 506 can be any sort of commands. In one preferred embodiment the commands are a command sequence understandable by the wireless web access device 110. In one embodiment, the commands sent by the navigation control unit 120 represent a keypress sequence equivalent to a sequence of manual keypresses on the integral user controls 112. In the simplest example, each command sent to the wireless web access device 110 is equivalent to a single press on one of the integral user controls 112. In this embodiment, each command is a string representing a predetermined sequence of keypresses. The keypress representation is preferably determined with reference to the identity information obtained in step 502, such that the navigation control unit 120 is able to operate with a wide variety of wireless web access devices 110. In one embodiment, the keypress sequence is obtained with reference to a lookup table stored in the navigation control unit 120, such that each user control 122 maps to a plurality of stored keypress sequences and one of the keypress sequences is selected according to the identity information of the wireless web access device 110. The keypress sequence is then used to form the command or a sequence of commands, depending upon the communication protocol required for communication with the identified web access device 110. In another embodiment, the command includes a combination of wireless web access device commands and keypress commands. For example, the command could include a power on command, a select browser command, and then a keypress combination representing a series of single presses of the integral user control buttons 112. Other types of wireless web access device 110 commands include commands specific to a particular device.

The control commands sent in step 506 will now be described in more detail. A first group of user controls 122 represent most commonly used functions suitable for controlling the wireless web access device 110. One common functionality would be navigation functions for navigation of a local or global computer network using commands such as back, ford, stop, refresh, scroll up, scroll down and select. These first group of user controls 122 may directly replicate equivalent integral user controls 112 on the wireless web access device 110. It is advantageous to provide these simple user controls on the navigation control unit 120. The navigation control unit 120 has user controls 122 which are easier to use than the integral user controls 112 of the wireless web access device 110, for example by being larger or having improved ergonomics.

Another group of the user controls 122 provide improved functionality over the integral control buttons 112. This second group of controls perform higher level functions (described below). The navigation control unit 120 may have only the first group, or only the second group, or preferably both groups of user controls 122, or any combination of user controls 122.

In one preferred embodiment, one actuation of the user controls 122 of the navigation control unit 120 represents a plurality of button presses required to perform the equivalent function using the integral user controls 112 of the wireless web access device 110. The controls may perform a wide variety of higher level functions, depending on the nature and type of the wireless web access device 110.

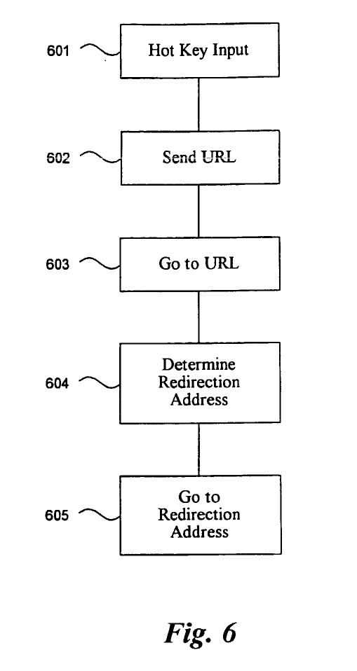

In one embodiment, one actuation of the user controls 122 of the navigation control unit 120 represents an e-commerce or purchase command. For example, the user control 122 could be configured as a “purchase” button and a command would be sent to the e-commerce web page requesting to purchase a product. A retailer could sell navigation control units 120 that contained a user control 122 programmed to purchase, say, the book-of-the-month and proceed to complete the e-commerce transaction based on payment and delivery information stored on a server. In an alternative embodiment, an electronic cash chip or e-wallet coupled with the navigation control unit 120 could be used to provide payment. Electronic cash could be stored on a electronic cash chip, a smart card, a counter to hold electronic money, or any other suitable device. In another alternative embodiment, a user control 122 could provide identification or authentication information about the user of the navigation control unit 120. Authentication technology (as described in relation to FIG. 6) could also be used to increase the security and reliability of the e-commerce or purchase transaction.

In one embodiment, one of the user controls 122 could be configured to redirect the user to a game playing web site. The user controls 122 could be designed to facilitate web-based games, whether the user controls 122 are a gaming input device such as a thumb pad or joystick or a user control 122 designed to select choice ‘b’ in a trivia game. Advertising revenue or playing fees could generate revenue based on the user of the web-based games. In an alternative embodiment, games are stored locally on the navigation control unit 120, and one or more user controls 122 or other user input devices are used to play the games.

In another embodiment, one of the user controls 122 could be configured to redirect the user to a betting web site. The user controls 122 could be designed to facilitate gambling games and games of chance. Payment authentication, or credit card information could be transmitted from the navigation control unit 120 in order to provide a mechanism for transferring finds.

In another embodiment, one of the user controls 122 could be configured to send commands to a television or personal computer. In this respect, the navigation control unit 120 could act as a remote control for a television or personal computer. This is particularly valuable with interactive television, where the wireless web access device 110 could be, say, an interactive television and the user controls 122 could be used both to redirect the browser on the interactive television to another site and to control functions of the interactive television, such as power, volume, channel etc.

In another embodiment, the redirection based on actuating a user control 122 can be based on the users location. The location information can be generated from a separate GPS receiver (either coupled to the navigation control unit 120 or the wireless web access device 110), an integral GPS receiver, other location determining systems based on mobile phone technology and/or triangulation (e.g. cell-side triangulation), or simply user input This provides a wealth of possibilities for customized redirection of users, such as tying the redirection web site to a nearby tourist location or providing country-specific devices for visitors.

In another embodiment, various business functions could be provided with the navigation control unit 120. These functions could be anything designed to facilitate business, such as order taking, inventory control, expense tracing, or local corporate data storage. Each of the functions would preferably be facilitated by the use of user controls 122.

In one example, a selected one or more of the user controls 122 have a pre-defined hot key, or predefined links function (depicted as hot key user controls 123). These hot keys 123 each command the wireless web access device 110 to open a connection to a particular web site. Each of these hot keys 123 links to a predetermined site, such that the user may easily access a selected few predetermined sites very conveniently. Advantageously, the user obtains access to these predetermined web sites without having to use or even understand other navigation controls on the wireless web access device 110 or on the control unit 120.

FIG. 6 shows a preferred method for performing higher level controls such as the hot key function 123 of a user control 122.

At step 601 a user control 122, preferably a hot key 123, is activated or actuated by the user.

At sat 602 the navigation control unit 120 sends control commands to the wireless web access device 110. These control commands may depend upon the current state of the wireless web access device 110. For example, control commands to establish a web connection or open a browser function may be required. In a preferred embodiment the control commands include sending a URL. Conveniently, the URL is sent as a keypress sequence. As will be described below, the URL preferably contains information identifying an address for the navigation server 125, information identifying the user control 122 actuated, and information identifying the navigation control unit 120 or user.

In one example, the URL comprises three fields. A first field gives a web address, preferably in a standard format such as “http://www.serveraddress.xxx”. A second field provides an identifier unique to the navigation control unit 120, or unique to a predetermined group of navigation control units, such as an alphanumeric sequence of 6, 8 or 10 characters allocated to the navigation control unit 120 during manufacture. In this example the unique identifier is “XXX12345”. The third field identifies the user control 122 activated by the user as determined in step 601. In this example the user activated key number “3”. The complete URL is sent, for example, as the character sequence “http://www.serveraddress.xxx12345/3”.

The URL may require a complicated keypress sequence. A wireless web access device 110 may have integral user controls 112 in a 4×3 number keypad layout, where each number key is used to obtain an extended alphanumeric character set by repeated keypresses. For example, the “1” button is pressed twice to give the letter “A”, or pressed three times to give the letter “B”. Hence, entering the URL manually requires many keypresses on the integral user controls 112. In the above example, the URL contains 39 characters, each of which may require several button presses by the user on the integral user controls 112, typically at least a total of 60 presses. By contrast, the user need only perform one keypress on the pre-defined user control 122 of the navigation control unit 120 to achieve the same result, giving a significant advantage.

In step 603 the wireless web access device 110 responds to the URL sent from the navigation control unit 120 and attempts to access the web address identified by the URL, using browser functions within the wireless web access device 110. The first field preferably identifies a predetermined navigation server 125, which receives the URL request from the wireless web access device 110.

In step 604 the navigation server 125 uses the second and third fields of the URL to determine a redirection address, and returns the redirection address to the wireless web access device 110. The redirection address is a second URL. At step 605 the wireless web access device 110 is redirected to the redirection address supplied from the navigation server 125. The redirection address can be any URL or computer resource. Examples include, but are not limited to, URLs associated with the seller of the navigation control unit 120, e-mail portals, retailers, information sites, news sites, weather sites, sports sites, government sites, technical support sites, user home pages, pages configured by a user, advertiser sites, billing sites, portals, etc.

The redirection address is conveniently determined with reference to a lookup table stored on the navigation server 125. In his example, the second and third fields provide the information “XXX12345/3” and the redirection address is returned as a web site corresponding to user controls 122 number “3” on navigation control unit 120 number “XXX12345”. The web site may be visibly labeled on the user control 122 or adjacent thereto for the user. For example, the user control 122 number “3” is labeled “weather” and the redirection address corresponds to a web site giving weather information.

The redirection action takes place at the navigation server 125, such that the navigation control unit 120 is relatively dumb. In other words, the navigation control unit 120 preferably employs a thin client. One benefit is that if the location of the desired web site changes or if it is desired to substitute another web site, then reprogramming is performed centrally at the navigation server 125.

In one embodiment, the navigation control unit 120 stores user specific information, and such information is delivered to the wireless web access device 110, for example, when accessing a particular predetermined web site from one of the user controls 122. Additionally or alternatively, such user information is supplied from the navigation control unit 120 in response to an interrogation signal issued from the wireless web access device 110.

User specific information stored on a navigation control unit 120 and transmitted to the wireless web access device 110 can be any of a variety of types of information. In one preferred embodiment, authentication information is transmitted to the wireless web access device 110. This authentication information can be directed to authenticating the user or the navigation control unit 120 hardware, and could include authentication of users at any location at a given time. This could be particularly useful as a preliminary security measure or as a security check-in for a security guard on rounds. Authentication information could be as simple as the serial number of the navigation control unit 120, or could include more sophisticated measures such as hashing or encrypting the serial number based on some other variable unknown to anyone but the actual hardware device owner and the authenticator.

Similarly, security information is transmitted from the navigation control unit 120 in another preferred embodiment This could include encrypted identifications or passwords, public or private keys, biometric data based on a biometric reader within the navigation control unit 120, or other security technology, such as secure ID authentication technology.

In another embodiment, payment information is transmitted from the navigation control unit 120. This could include credit card information, user identification, or information regarding electronic cash transactions. In yet another alternative embodiment, location information is transmitted from the navigation control unit 120, which could be based on an integral GPS receiver or other location-finding device.

In another embodiment, electronic coupon information is transmitted from the navigation control unit 120. This could include any information about an electronic coupon, including authorization, retailer or service provider identification, requirements, expiration date, status, value, or any other relevant information. The electronic coupon information could be stored on the navigation control unit 120 on a removable device, such as an electronic coupon chip, or in memory on the navigation control unit 120. In one embodiment, the electric coupon information is initially received from a web site visited by the user of the navigation control unit 120.

Other capabilities, either based on hardware, software, or a combination of both, can be provided with a navigation control unit 120 consistent with the present invention. Music capability could be added, such as by an MP3 player, a CD player, FM radio, or other music source. Video capability could be added, such as by a television antenna or DVD player.

In another alternative embodiment, user specific information is stored on the navigation control unit 120. For example, favorite web sites or URLs, locations visited, the last location visited, or other information could be stored locally, together with associated cookies for such visited sites. Access to this information, indirectly or directly, could be provided through a user control 122. Other stored information could include speed dial information, maps, reference materials, etc. Moreover, rather than storing just information, the navigation control unit may store in its memory, or memory associated with the wireless web access device, executable software applications or utilities. Examples of such applications include business applications, such as mathematical algorithms or calculators (e.g., a mortgage calculator), video games, communication applications (e.g., new wireless protocols, electronic mail applications), imaging/graphics applications (e.g. still or moving image viewers), sound/music applications (e.g., customized ringing tones, music playback decoders), security applications, or applications directed to a particular interest, such as copies, engineering, met science, shopping, business, diet/fitness, etc. The wireless web access device may download such applications from the navigation server, or another server.

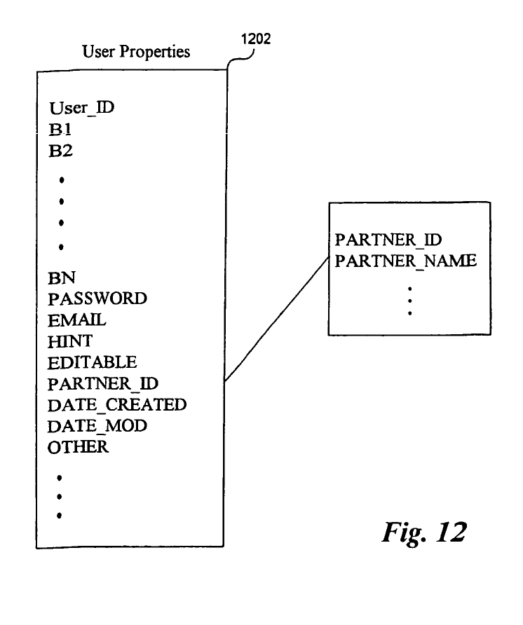

In a typical wireless web access device 110, navigation generally takes place using software controls within the device using the integral user controls 112. However, in the preferred embodiment of the present invention the navigation control unit 120 provides an external hardware controller to determine navigation of the wireless web access device 110. The navigation control unit 120 readily links to predetermined web sites that are of interest to the user. The user controls 122 may be tailored to the needs of each user, such as providing financial, travel, sports or any other information, by changing the central lookup table or personalization table 1040 (described in reference to FIG. 12) at the navigation server 125. The unique identifier allows each navigation control unit to have a different response, based on the redirection addresses stored at the navigation server. Further information regarding the navigation server and associated functions may be found in U.S. patent application Ser. No. ______, entitled “Navigation Server for Use with, for Example, a Wireless Web Access Device having a Navigation Control Unit,” filed concurrently herewith. In an alternative embodiments the functions described herein are stored locally on the wireless web access device 110, with the navigation control unit being a hardware and/or software component formed or incorporated within the wireless device.

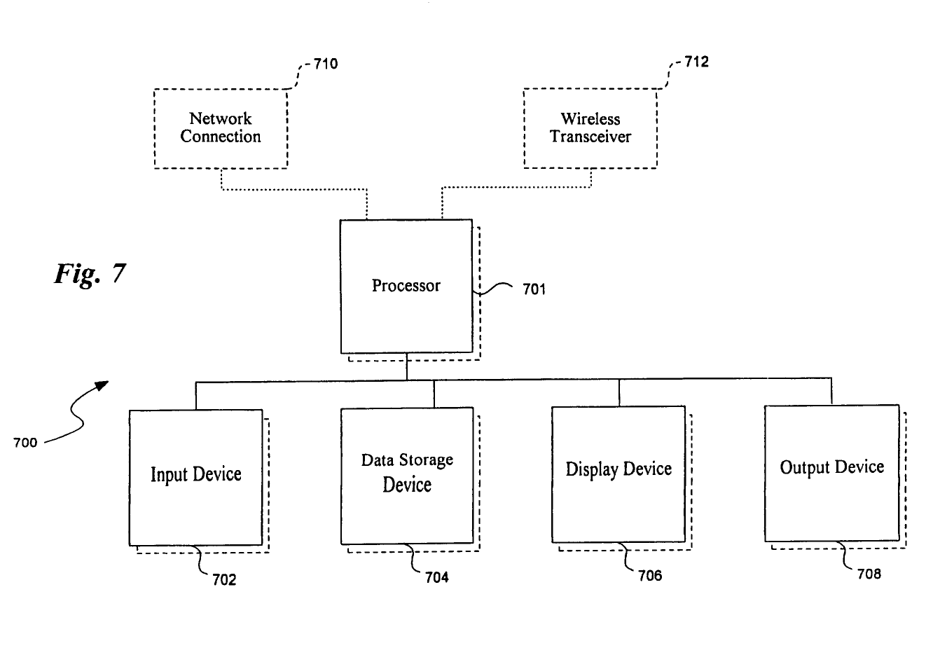

While aspects of the invention are generally described herein for use with a wireless web access device, such as a cell phone, aspects of the invention may be employed with other computer system configurations. Thus, FIG. 7 and the following discussion provide a brief, general description of a suitable computing environment in which aspects of the invention can be implemented. Although not required, aspects and embodiments of the invention will be described in the general context of computer-executable instructions, such as routines executed by a general purpose computer, e.g., a server or personal computer. Those skilled in the relevant art win appreciate that the invention can be practiced with other computer system configurations, including Internet appliances, hand-held devices, wearable computers cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

The invention can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory stage devices. Aspects of the invention described below may be stored or distributed on computer-readable media, including magnetic and optically readable and removable computer discs, stored as firmware in chips (e.g., EEEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to FIG. 7, one embodiment of the invention employs a computer 700, such as a personal computer or workstation, having one or more processors 701 coupled to one or more user input devices 702 and data storage devices 704. The computer is also coupled to at least one output device such as a display device 706 and one or more optional additional output devices 708 (e.g., printer, plotter, speakers, tactile or olfactory output devices, etc.). The computer may be coupled to external computers, such as via an optional network connection 710, a wireless transceiver 712, or bot

The input devices 702 may include a keyboard and/or a pointing device such as a mouse. Other input devices are possible such as a microphone, joystick, pens game pad, scamper, digital camera, video camera, and the like. The data storage devices 704 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to a network such as a local area network (LAN), wide area network (WAN) or the Internet

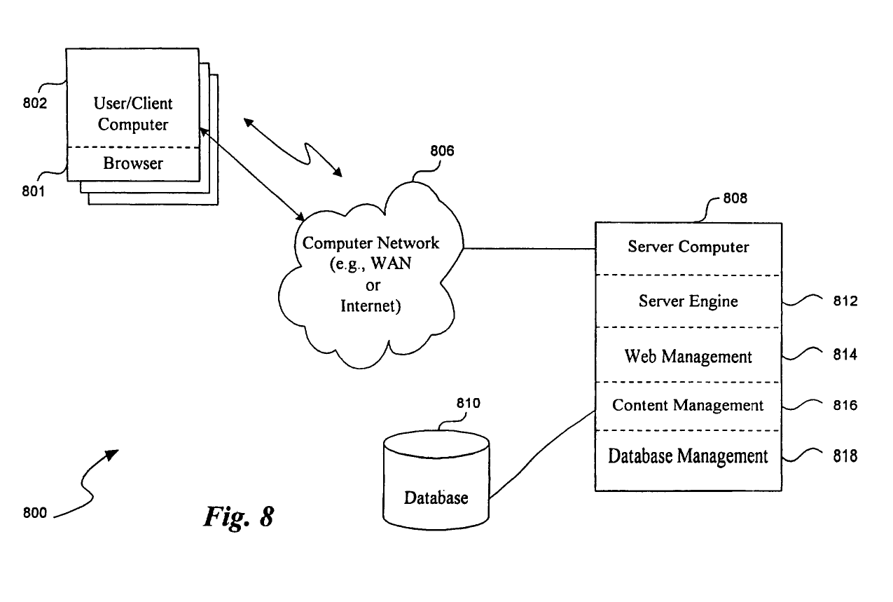

Aspects of the invention may be practiced in a variety of other computing environments. For example, referring to FIG. 8, a distributed computing environment with a web interface includes one or more user computers 802 in a system 800 are shown, each of which includes a browser program module 801 that permits the computer to access and exchange data with the Internet 806, including web sites within the World Wide Web portion of the Internet The user computers may include one or mote central processing units or other logic-processing circuitry, memory, input devices (e.g., keyboards and pointing devices), output devices (e.g., display devices and printers), and storage devices (e.g., magnetic, fixed and floppy disk drives, and optical disk drives), such as described above with respect to FIG. 7. User computers may include other program modules such as an operating system, one or more application programs (e.g., animation or graphics applications, word processing or spread sheet applications), and the like. The user computers 102 include wireless computers, such as mobile phones, personal digital assistants (PDA's), palm-top computers, etc., which communicate with the Internet via a wireless link.

At least one server computer 808, coupled to the Internet or World Wide Web (“Web”) 806, performs much or all of the functions for receiving, routing and storing of electronic messages, such as web pages, audio signals and electronic images, such as vocal audio and animation images. While the Internet is shown, a private network, such as an intranet may likewise be used herein. A database 810, coupled to the server computer, stores much of the web pages and content exchanged between the user computers. The server computer, including the database, may employ security measures to inhibit malicious attacks on the system, and to preserve integrity of the messages and data stored therein (e.g., firewall systems, secure socket layers (SSL), password protection schemes, encryption, and the like).

The server computer 808 includes a server engine 812, a web page management component 814, a content management component 816 and a database management component 818. The server engine performs basic processing and operating system level tasks. The web page management component handles creation and display or routing of web pages. Users may access the server computer by means of a URL associated therewith. The content management component handles most of the functions in the embodiments described herein. The database management component includes storage and retrieval task with respect to the database, queries to the database, and storage of data such as animation graphics and audio signals.

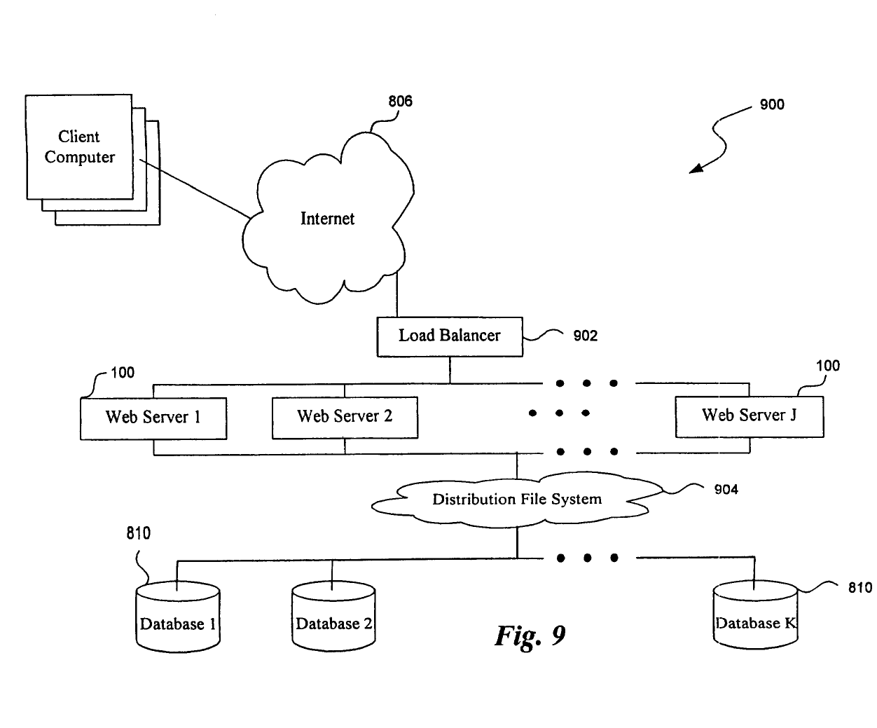

Referring to FIG. 9, an alternative embodiment to the system 800 is shown as a system 900. The system 900 is substantially similar to the system goo, but includes more than one web server computer (shown as server computers 1, 2, . . . J). A web load balancing system 902 balances load on the several web server computers. Load balancing is a technique well-known in the art for distributing the processing load between two or more computers, to thereby more efficiently process instructions and route date. Such a load balancer can distribute message traffic, particularly during peak traffic times.

A distributed file system 904 couples the web servers to several databases 810 (shown as databases 1, 2 . . . K). A distributed file system is a type of file system in which the file system itself manages and transparently locates pieces of information (e.g., content pages) from remote files or databases and distributed files across the network, such as a LAN. The distributed file system also manages read and write functions to the databases.

The web pages noted herein are stored as display descriptions, graphical user interfaces, or other methods of depicting information on a computer screen (e.g., commands, links, fonts, colors, layout, sizes and relative positions, and the like), where the layout and information or content to be displayed on the page is stored in a database. In general a “link” refers to any resource locator identifying a resource available on a network, such as a display description provided by an organization having a site or node on the network. A “display description,” as generally used herein, refers to any method of automatically displaying information on a computer screen in any of the above-noted formats, as well as other formats, such as email or character/code-based formats, algorithm-based formats (e.g., vector generated), or matrix or bit-mapped formats. While aspects of the invention are described herein using a networked environment, some or all features may be implemented within a single-computer environment

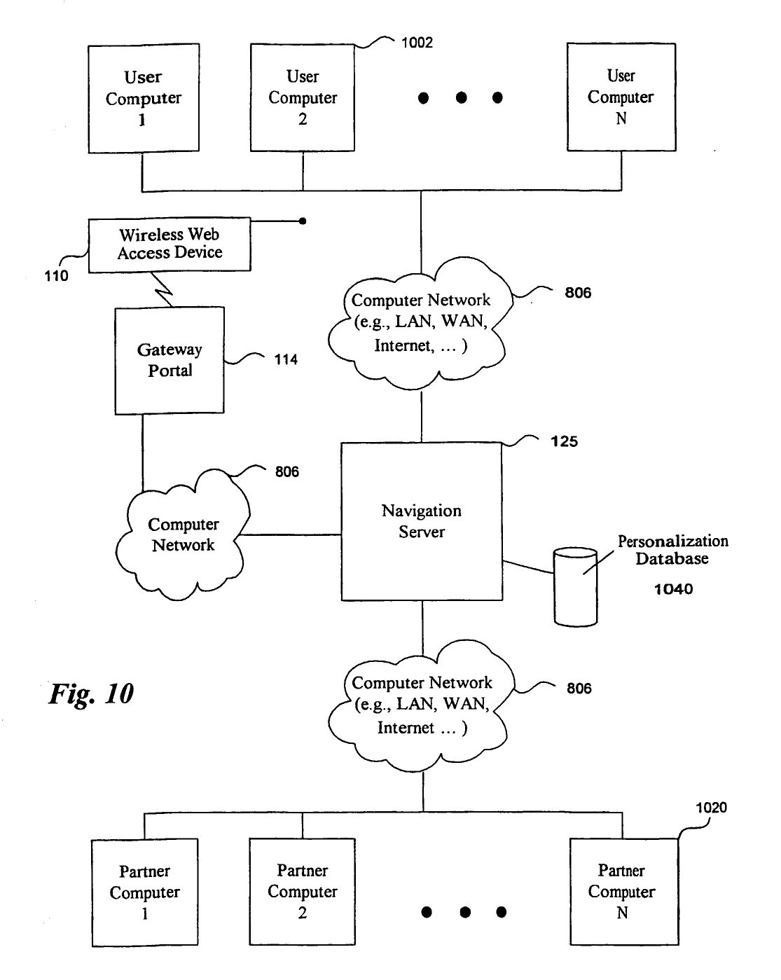

FIG. 10 depicts a schematic view of a suitable embodiment of the navigation server 125. The navigation server 125 can be a computer 700 configured as a server 808 or the navigation server 125 can be a distributed computing system 800 (as described more filly in connection with FIGS. 8-9). The navigation server 125 is preferably a robust, fault-tolerant system with input/output capabilities and access to storage, such as in a database 810. Alternatively, multiple servers can be used in place of the navigation server 125, as described in the web load balancing system 902 and the multiple server system 900 discussed in relation to FIG. 9. The navigation server 125 is preferably connected to a personalization database 1040 used for storing data associated with users of the navigation server 125, as described below.

The navigation server 125 is preferably connected to one or more user computers 1002 via a computer network 806, such as a WAN, LAN, or the Internet Each user computer 1002 can be substantially similar to the computer 700 as described in relation to FIG. 7. The user computers 1002, like the computer 700, may be any type of computer. The user computers 1002 may be used in one embodiment to allow the users of navigation control units 120 to modify some or all of the settings of their navigation control units 120. The user computers 1002 are optional and are not required for operation of the navigation server 125.

The navigation server 125 is also preferably connected to one or more partner computers 1020 via a computer network 806, such as a WAN, LAN, or the Internet. Each partner computer 1020 can be substantially similar to the computer 700 as described in relation to FIG. 7. The partner computers 1020, like the computer 700, may be any type of computer. The partner computers 1020 may be used to modify the configurations of one or more navigation control units 120. In one embodiment, a partner computer 1020 represents a computer used by a retailer that sells or distributes multiple navigation control units 120 that are similarly configured In another embodiment, no partner computers 1020 are necessary and partners host a navigation server 125 themselves. In yet another embodiment, no partner computers 1020 are necessary.

As described in relation to FIG. 1, in one embodiment the navigation server 125 is connected with one or more gateway portals 114 via a computer network 806, such as a WAN, LAN, or the Internet. The gateway portal 114 communicates with one or more wireless web access devices 110, preferably through a wireless communications protocol such as WAP.

One preferred embodiment for operation of the navigation server 125 with the user on a wireless web access device 110 equipped with a navigation control unit 120 will now be described with reference to the flowchart of FIG. 11 as a routine 1100. Each of the blocks depicted in FIG. 11 and the other flowcharts is of a sub-operation type that is either well-known in the art or may be implemented by those skilled in the relevant art based on the detailed description provided herein. Each block may well include a sequence of operations that need not be described herein. One skilled in the art will recognize that the order of blocks in FIG. 11 and other figures of the application can be modified as long as the resulting order in not inconsistent with the basic functionality.

At step 1102 the navigation server 125 receives a request from a user operating a navigation control unit 120 on a wireless web access device 110. In one embodiment, the user request includes information about the navigation control unit 120 being used, such as information identifying the user or a serial number or similar piece of data identifying the exact navigation control unit 120 being used or the class of navigation control unit being used. The class of navigation control unit 120 being used can be related to the manufacturer or partner associated with the navigation control unit 120 (e.g. the partner who programmed or distributed the unit). In this embodiment, the user request also includes information about the user control 122 actuated by the user and, if relevant, the value of the input on the user control 122 by the user (e.g. the button that was pushed, direction and force of moving a joystick, direction and extent of rotation of a rotary pads etc.). The user request can be in any form and can include any combination of information, including one or more of the information identifying the user, user control 122 information, times, authentication information, e-commerce orders, payment information, user information, or any other types of data.

At step 1104 the user request is parsed to extract out certain relevant information. In one preferred embodiment, the user request takes the general form of the URL described in relation to step 602 of FIG. 6. As described in relation to FIG. 6, this step is optional and is not required if the user request is received by the navigation server 125 in a format that does not require parsing.

At step 1106 the user request, whether parsed in step 1104 or not, is validated to confirm that the information is in the right format. In one embodiment, each value extracted during the parsing process is validated in order to ensure that the information is in the right format and has not been corrupted or incorrectly entered. If the information is validated in step 1104, the process can continue. If there is an error detected in step 1104, many options for an error procedure 1108 are available, including but not limited to rejecting the request, attempting to correct the error, ignoring the error and notifying the user. Routines to perform step 1106 are well-known to one skilled in the art

In step 1110, the navigation server 125 queries the personalization database 1040 in order to ascertain a redirection address based on the user request. In one embodiment, the query includes information identifying the navigation control unit 120 and information about which user control 122 was actuated. The information identifying the navigation control unit 120 can be a serial number, partner identification, or any other type of data. In another embodiment, no identifying information is available and only the user control 122 actuation information is used to search the personalization database 1040.

In a preferred embodiment, the personalization database 1040 is searched based on both the navigation control unit 120 identifying information and the information about the user control 122 that was actuated. The personalization database preferably contains a redirection URL associated with each user control 122 for each navigation control unit 120 (described more filly in connection with the user properties table of FIG. 12). Therefore, when information about both the navigation control unit 120 and the user control 122 are available, a redirect URL is associated with that information in a lookup table in the personalization database 1040. In some preferred embodiments, the user of the navigation control unit 120, the partner associated with the navigation control unit 120, or the operator of the navigation server 125 can change the values in the personalization database 1040, including the redirect URL associated with a user control 122 on a particular navigation control unit 120.

In step 1112 the navigation server 125 receives the redirect address from the personalization database 1040 in response to its query. In step 1114, the navigation server saves information regarding the user request, time, and redirect address in a database, which could be the personalization database 1040 or any other database. Information saved in this fashion can be used to collect usage information about users on navigation control units 120 for marketing, e-commerce, advertising, trouble-shooting, system optimization or other purposes.

In step 1116 a redirect message is transited to the wireless web access device 110 associated with the navigation control unit 120. In one embodiment, the redirect message is transmitted through a computer network 906 and gateway portal 114 and then transmitted to the wireless web access device 110. The redirect message can contain only the redirect URL or it can contain a redirect message designed for the particular wireless web access device and its protocols.

FIG. 12 depicts a preferred embodiment of the user properties lookup table 1202, which can be stored in the personalization database 1040 or any database accessible by the navigation server 120. The user properties lookup table 1202 contains one or more data entries providing information related to a particular user or navigation control unit 120. First the user properties lookup table preferably contains a user identification (depicted as USER_ID in FIG. 12), which can be a serial number of the navigation control unit 120, an identification of a partner, an identification of the user, or any identifying information The table also preferably contains one or more entries associated with user controls 122 (depicted as B1 to BN in FIG. 12). In one embodiment, these entries will have a redirection URL associated with each user control 122 that has been or can be configured.

The user properties lookup table 1202 can also contain data used for authentication of a user desiring to change his or her settings, embodied in FIG. 12 by PASSWORD, EMAIL, and HINT. One skilled in the art would recognize that there are a wide variety of authentication measures hat are feasible, including password protection and password delivery to a confirmed e-mail address. One skilled in the art would also recognize that there are feasible mechanisms designed to help a user remember his or her password. The EDITABLE entry contains information about what entries can be changed by an authenticated user. In one embodiments the EDITABLE entry contains a string of binary numbers to indicate which user control fields are editable by the user. For example, if there were six user control entries, and only the first three were configurable by the user, the EDITABLE entry would be “111000” (in other words, B1-B3 would be configurable, and B4-B6 would not).

In one preferred embodiment, each USER_ID entry in the user properties lookup table 1202 is associated with one or more PARTNER_ID entries. Each PARTNER_ID entry indicates the identification number of one or more portals or other partners that the navigation control unit 125 was branded for, was sold by, or is associated with. Multiple PARTNER_ID's are possible as a navigation control unit 125 could be associated with, for example, an Internet portal and a music store, each one having different capacities to modify the user properties lookup table 1202. The partner table associated with the PARTNER_ID entry has a partner name linked to each PARTNER_ID.

The user properties lookup table 1202 may also have a DATE_CREATED entry, which stores a date value indicating the date the table was created, and a DATE_MODIFIED entry, which stores a date value indicating the date that the table was last modified.

The user properties lookup table 1202 should not be limited to the above entries, as virtually any type of data about the user, partner, or navigation control unit 125 can be stored in the table. This includes statistical information about usage, such as the number of times a user actuates a user control 122, where the user is redirected to, the time and user location for each actuation, etc.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole, and not to any particular portions of this application.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other systems for wirelessly accessing computer resources, not necessarily for the web based system described above. The elements and acts of the various embodiments described above can be combined to provide further embodiments.

All of the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general in the following claims, the terns used should not be construed to limit the invention to the specific embodiments disclosed in the specification and the claims, but should be construed to include all systems that operate under the claims to provide a method for providing access to computer resources. Accordingly, the invention is not limited by the disclosure, but instead the scope of the invention is to be determined entirely by the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium Accordingly, the inventors reserve the right to add additional claims after filing the application to pursue such additional claim forms for other aspects of the invention.

We claim:

1. A method for controlling navigation within the Internet by a user on a wireless web access device, the method comprising:
receiving an input from a user of a navigation control unit, wherein the navigation control unit is coupled to the wireless web access device and wherein the user input is based on actuation of a user control on the navigation control unit by the user;
generating a user command, wherein the user command includes information about the user control actuated by the user;
transmitting the user command to the wireless web access device using a communications link;
transmitting the user command to a navigation server;
receiving a redirection command from the navigation server, wherein the redirection command includes an address of a web page on the Internet; and
accessing the address specified in the redirection command using a browser located on the wireless web access device and retrieving for display the web page.

2. The method of claim 1 wherein the communications link between the navigation control unit and the wireless web access device is a cord.

3. The method of claim 1 wherein the communications link between the navigation control unit and the wireless web access device is a wireless link.

4. The method of claim 1 wherein the user command includes a URL and information identifying the navigation control unit.

5. The method of claim 1 wherein the redirection command includes a redirection URL.

6. The method of claim 1 wherein the user command includes a URL, wherein further URL includes an address for a navigation server, a serial number for the navigation control unit, and information about the user control actuated by the user.

7. A method for controlling navigation over a computer network by a user on a wireless network access device, comprising:
receiving all input from a user to a network navigation control unit wherein the user input is based on the actuation of a user control on the network navigation control unit by the user;
generating a user command, wherein the user command includes information about the user control actuated by the user; and
transmitting the user command from the network navigation control unit to the wireless network access device using a communications link.

8. The method of claim 7 wherein the computer network is the Internet, and wherein the user command includes a URL, wherein further the URL includes an address for a navigation server, a serial number for the navigation control unit, and information about the user control actuated by the user.

9. A method for controlling navigation of a computer network by a user on a wireless web access device, comprising:
receiving a user command from a navigation control unit via a communications link, wherein the user command includes information about the user control actuated by the user;
transmitting the user command to a navigation server;
receiving a redirection command from the navigation server, wherein the redirection command includes an address of a resource available from the computer network; and
accessing the resource from the computer network based on the address specified in the redirection command using a browser located on the wireless web access device.

10. The method of claim 9 wherein the user command further includes a URL and information identifying the navigation control unit, wherein per the URL is an address for the navigation server.

11. A computer-readable medium containing a data structure for use by a navigation server, the data structure comprising:
at least one URL, wherein each URL comprises:
a URL address for the navigation server;
information identifying a navigation control unit associated with the URL; and
information identifying at least one user control on the navigation control unit actuated by a user.

12. The computer-readable medium of claim 11 wherein the computer-readable medium is a logical node in a computer network receiving the contents.

13. The computer-readable medium of claim 11 wherein the computer-readable medium is a computer-readable disk.

14. The computer-readable medium of claim 11 wherein the computer-readable medium is a data transmission medium transmitting a generated data signal containing the contents.

15. The computer-readable medium of claim 11 wherein the computer-readable medium is a memory of a computer system.

16. The computer-readable medium of claim 11 further comprising information identifying a payment mechanism for providing payment by the user.

17. A method for controlling navigation within the Internet by a user on a wireless web access device with integral navigation control unit functionality, the method comprising:
receiving an input firm a user of a wireless web access device, wherein the user input is based on actuation of a user control on the wireless web access device by the user;
generating a user command, wherein the user command includes information about the user control actuated by the user;
transmitting the user command to a navigation server;
receiving a redirection command from the navigation server, wherein the redirection command includes an address of a web page on the Internet; and
accessing the address specified in the redirection command using a browser located on the wireless web access device and retrieving for display the web page.

18. A method for reprogramming a wireless network access device with a navigation control unit, comprising:
generating a configuration command, wherein the configuration command is based on the wireless network access device; and
transmitting the configuration command from the network navigation control unit to the wireless network access device using a communications link.

19. The method of claim 18 wherein the configuration command is automatically generated and transmitted.

20. The method of claim 18 flyer comprising receiving information identifying the wireless network access device.

21. The method of claim 18 wherein the configuration command includes a series of keypresses, wherein the series of keypresses replicates the keypresses a user of the wireless network access device would have to enter to reprogram the wireless network access device.

22. The method of claim 18 wherein the configuration command includes information to perform at least one of the following functions: setting the screen display, configuring a home page, configuring a ringing tone for the wireless network access device, configuring a gateway portal and configuring bookmarks stored on the wireless network access device.

23. A method for controlling navigation within the Internet by a user on a wireless web access device, the method comprising:
receiving an input from a user of a navigation control unit, wherein the navigation control unit is coupled to the wireless web access devise and wherein the user input is based on actuation of a user control on the navigation control unit by the user, and wherein the user command includes information identifying the navigation control unit and an address for a navigation server, and wherein the computer network is the Internet;
generating a user command, wherein the user command includes information about the user control actuated by the user; and
transmitting the user command to the wireless web access device using a communications link.

24. The method of claim 23 wherein the user command further includes information identifying a product or service to be purchased by the user and information identifying user payment information.

25. The method of claim 23 wherein the user command further includes information providing authentication or security for user information.

26. The method of claim 23 wherein the user command further includes location information for the navigation control unit.

27. The method of claim 23 wherein the user command further includes electronic coupon information.
